(19) United States
(12) Patent Application Publication
(10) Pub. No.: US 2026/0331745 A1
(43) Pub. Date: Oct. 22, 2026

(54) WAVEGUIDE MEMBER, WAVEGUIDE DEVICE, AND METHOD OF MANUFACTURING WAVEGUIDE MEMBER

(71) Applicant: TAIYO YUDEN CO., LTD., Tokyo (JP)

(72) Inventors: Yutaka AOKI, Tokyo (JP); Hitoshi TANAKA, Tokyo (JP); Hiroyuki KAMO, Tokyo (JP)

(73) Assignee: TAIYO YUDEN CO., LTD., Tokyo (JP)

(21) Appl. No.: 19/698,449

(22) Filed: Jun. 4, 2026

Related U.S. Application Data
(63) Continuation of application No. PCT/JP2024/030742, filed on Aug. 28, 2024.

(30) Foreign Application Priority Data
Dec. 12, 2023 (JP) 2023-209181

(51) Int. Cl. H01P 3/123; H01P 11/00

(52) U.S. Cl. CPC H01P 3/123; H01P 11/002

(57) ABSTRACT

A waveguide member includes a member made of a non-conductive material, the member including an upper surface, a lower surface, a belt portion having a first ceiling surface recessed from the lower surface toward the upper surface and extending in a belt shape, and a plurality of hole portions extending from the lower surface toward the upper surface and disposed adjacent to at least a part of the belt portion, the plurality of hole portions each having a second ceiling surface and a side peripheral surface, and a conductive film that covers at least the upper surface and the lower surface of the member, and the first ceiling surface of the belt portion, and the second ceiling surface and the side peripheral surface of each of the plurality of hole portions.

### CROSS-REFERENCE TO RELATED APPLICATION

This application is a continuation application of International Application PCT/JP2024/030742 filed on Aug. 28, 2024 and designated the U.S., which claims the benefits of priorities of Japanese Patent Application No. 2023-209181 filed on Dec. 12, 2023, the entire contents of which are incorporated herein by reference.

### FIELD

A certain aspect of the present disclosure relates to a waveguide member, a waveguide device, and a method of manufacturing a waveguide member.

### BACKGROUND

In recent years, research and development on sensing and communication using millimeter waves have been expanded, and an antenna having a high gain, low-loss, a wide bandwidth, and multiple channels has been required. In response to this, development of WRG (Waffle iron Ridge waveGuide) technology useful as a next-generation antenna and a waveguide has progressed (for example, Patent Document 1: International Publication Pamphlet No. WO 03/065497, and Patent Document 2: Japanese National Publication of International Patent Application No. 2011-527171). FIG. 3 of Patent Document 1 discloses a basic structure of the WRG. As a subordinate supplementary structure thereof, Patent Document 2 discloses a structure in which two conductive members constituting a basic structure are fixed outside a waveguide region as one of structures of the WRG in a high frequency band such as a millimeter wave. One of the features of the WRG technology is that separation walls are formed to prevent mutual coupling between adjacent waveguides in a plurality of waveguides in an antenna disposed from a millimeter wave IC (MMIC: Monolithic Microwave Integrated Circuit) to an antenna radiation aperture for transmitting and receiving a millimeter wave electromagnetic wave. This prevents leakage of the propagating electromagnetic wave, thereby keeping the transmission loss at the same level as that of the metal waveguide, and minimizing interference with the electromagnetic wave transmitted through another adjacent waveguide. In the microstrip waveguides and microstrip antennas used hitherto, such separation walls do not exist.

A main application field of the millimeter wave antenna is an application of imaging radar sensing having a plurality of transmission/reception channels. When a microstrip antenna is used for this antenna application, a loss in a waveguide is large, and interference due to mutual coupling between waveguides and antenna radiation elements adjacent to each other in the antenna occurs, which may cause a problem in detection accuracy of an object or the like. On the other hand, when the WRG technology is used for such a multi-channel antenna, in addition to keeping the loss in the waveguide extremely low, the mutual coupling between the waveguides adjacent to each other in the antenna is greatly suppressed. In addition, the mutual coupling can be further suppressed by using the antenna radiation aperture suitable for WRG such as a mini-horn antenna or a slot antenna. This enables correct signal transmission/reception between the antenna transmission/reception aperture and the MMIC terminal that performs signal transmission and reception. As a result, for example, in millimeter wave radar sensing, it is possible to correctly detect a signal of the object included in a received electromagnetic wave from the object and accurately detect the object.

In the WRG technology, the separation walls are realized by magnetic walls provided on both sides of the ridge waveguide, and are realized by a structure having periodicity such as a rod array. When the magnetic wall is realized by a single rod array, a separation effect of about 30 dB can be expected. In order to further enhance the separation effect, when two rod rows are provided between two ridge waveguides, the separation effect is expected to be about 40 dB, and high separation performance suitable for an array antenna can be realized. Such a magnetic wall has a confinement function of stopping propagation of an electromagnetic wave in a corresponding frequency band. The structure constituting this is called an artificial magnetic conductor (AMC), and can be realized by a structure other than the rod array (for example, Patent Document 2: Japanese National Publication of International Patent Application No. 2011-527171). For example, the description in the middle of paragraph 0015 of Patent Document 2 is instructive, which states: “the texture or structure is often periodic or quasi-periodic and is made to interact with waves to macroscopically operate as an artificial magnetic conductor (AMC), an electromagnetic band gap (EBG) surface, or a soft surface”.

Patent Document 3 (Japanese National Publication of International Patent Application No. 2018-511187) and Patent Document 4 (Japanese Patent Application Publication No. 2017-130924) disclose means for adjusting characteristics in a ridge waveguide which is a WRG waveguide, and provide means for adjusting waveguide characteristics when the ridge waveguide is utilized in a wide range of applications.

### SUMMARY OF THE INVENTION

According to a first aspect of the present disclosure, there is provided a waveguide member including: a member made of a non-conductive material, the member including an upper surface, a lower surface, a belt portion having a first ceiling surface recessed from the lower surface toward the upper surface and extending in a belt shape, and a plurality of hole portions extending from the lower surface toward the upper surface and disposed adjacent to at least a part of the belt portion, the plurality of hole portions each having a second ceiling surface and a side peripheral surface; and a conductive film that covers at least the upper surface and the lower surface of the member, and the first ceiling surface of the belt portion, and the second ceiling surface and the side peripheral surface of each of the plurality of hole portions.

According to a second aspect of the present disclosure, there is provided a waveguide member including: a first member made of a non-conductive material, the first member including an upper surface, a lower surface, a belt portion having a first ceiling surface recessed from the lower surface toward the upper surface and extending in a belt shape, and a plurality of hole portions extending from the lower surface toward the upper surface and disposed adjacent to at least a part of the belt portion, the plurality of hole portions each having a second ceiling surface and a side peripheral surface; a conductive film that covers at least the lower surface of the first member, the first ceiling surface of the belt portion, and the second ceiling surface and the side peripheral surface of each of the plurality of hole portions; and a second member provided on an upper surface side of the first member, the second member having a lower surface having conductivity.

According to a third aspect of the present disclosure, there is provided a waveguide member including: a member made of a non-conductive material, the member including an upper surface, a lower surface, a belt portion having a first ceiling surface recessed from the lower surface toward the upper surface and extending in a belt shape, and a plurality of hole portions penetrating from the lower surface to the upper surface and disposed adjacent to at least a part of the belt portion; and a conductive film covering all surfaces of the member.

According to a fourth aspect of the present disclosure, there is provided a waveguide device including: a waveguide member described above, wherein a waveguide is formed between the conductive film provided on the first ceiling surface and the conductive film provided on the upper surface, and an electromagnetic wave propagation barrier is formed by the conductive film provided in the plurality of hole portions.

According to a fifth aspect of the present disclosure, there is provided a waveguide device including: a waveguide member described above, wherein a waveguide is formed between the conductive film provided on the first ceiling surface and the second member, and an electromagnetic wave propagation barrier is formed by the conductive film provided in the plurality of hole portions.

According to a sixth aspect of the present disclosure, there is provided a method of manufacturing a waveguide member including: forming a member made of a non-conductive material, the member including an upper surface, a lower surface, a belt portion having a first ceiling surface recessed from the lower surface toward the upper surface and extending in a belt shape, and a plurality of hole portions extending from the lower surface toward the upper surface and disposed adjacent to at least a part of the belt portion, the plurality of hole portions each having a second ceiling surface and a side peripheral surface; and forming a conductive film that covers at least the upper surface, the lower surface, the first ceiling surface of the belt portion, and the second ceiling surface and the side peripheral surface of each of the plurality of hole portions of the member.

According to a seventh aspect of the present disclosure, there is provided a method of manufacturing a waveguide member including: forming a first member made of a non-conductive material, the first member including an upper surface, a lower surface, a belt portion having a first ceiling surface recessed from the lower surface toward the upper surface and extending in a belt shape, and a plurality of hole portions extending from the lower surface toward the upper surface and disposed adjacent to at least a part of the belt portion, the plurality of hole portions each having a second ceiling surface and a side peripheral surface; forming a conductive film that covers at least the lower surface of the first member, the first ceiling surface of the belt portion, and the second ceiling surface and the side peripheral surfaces of each of the plurality of hole portions; and forming a second member on an upper surface side of the first member, the second member having a lower surface having conductivity.

According to an eighth aspect of the present disclosure, there is provided a method of manufacturing a waveguide member including: forming a member made of a non-conductive material, the member including an upper surface, a lower surface, a belt portion having a first ceiling surface recessed from the lower surface toward the upper surface and extending in a belt shape, and a plurality of hole portions penetrating from the lower surface to the upper surface and disposed adjacent to at least a part of the belt portion; and forming a conductive film covering all surfaces of the member.

### BRIEF DESCRIPTION OF THE DRAWINGS

FIG. 1A is a plan view of a waveguide member according to a first embodiment.

FIG. 1B is a cross-sectional view taken along a line A-A in FIG. 1A.

FIG. 1C is a cross-sectional view of a waveguide device using the waveguide member according to the first embodiment.

FIGS. 2A and 2C are plan views illustrating a method of manufacturing a waveguide member according to the first embodiment.

FIGS. 2B and 2D are cross-sectional views taken along a line A-A in FIGS. 2A and 2C.

FIG. 3 is a cross-sectional view of a waveguide member and a waveguide device using the waveguide member according to a modification of the first embodiment.

FIG. 4A is a cross-sectional view of a waveguide member and a waveguide device using the waveguide member according to a second embodiment.

FIG. 4B is a cross-sectional view of a waveguide member and a waveguide device using the waveguide member according to a modification of the second embodiment.

FIG. 5A is a plan view of a waveguide member and a waveguide device using the waveguide member according to a third embodiment.

FIG. 5B is a cross-sectional view taken along a line A-A in FIG. 5A.

FIG. 5C is a cross-sectional view of a waveguide member and a waveguide device using the waveguide member according to a modification of the third embodiment.

FIGS. 6A to 6C are cross-sectional views illustrating a method of manufacturing a waveguide member according to the third embodiment.

FIG. 7A is a plan view of a waveguide member and a waveguide device using the waveguide member according to a fourth embodiment.

FIG. 7B is a cross-sectional view taken along a line A-A in FIG. 7A.

FIG. 7C is a cross-sectional view of a waveguide member and a waveguide device using the waveguide member according to a modification of the fourth embodiment.

FIGS. 8A to 8C are cross-sectional views illustrating a method of manufacturing a waveguide member according to a fourth embodiment.

FIG. 9A is a plan view of a waveguide member and a waveguide device using the waveguide member according to a fifth embodiment.

FIG. 9B is a cross-sectional view taken along a line A-A in FIG. 9A.

FIGS. 10A and 10B are cross-sectional views illustrating a method of manufacturing a waveguide member according to the fifth embodiment.

FIG. 11 is a block diagram illustrating a vehicle travel control device according to a sixth embodiment.

### DESCRIPTION OF EMBODIMENTS

The basic structure of WRG (Waffle iron Ridge waveGuide) is a structure in which a first conductive member including, for example, a ridge and a rod array and a second conductive member constituting a top plate are assembled. In recent years, in response to the expansion of the applications of the WRG technology, there is a demand for simply and inexpensively manufacturing waveguide members and waveguide devices using the WRG.

The present disclosure has been made in view of the above problems, and an object of the present disclosure is to simplify and reduce the cost of manufacturing a waveguide member and a waveguide device using the WRG technology.

Hereinafter, embodiments of the present invention will be described with reference to the drawings.

### First Embodiment

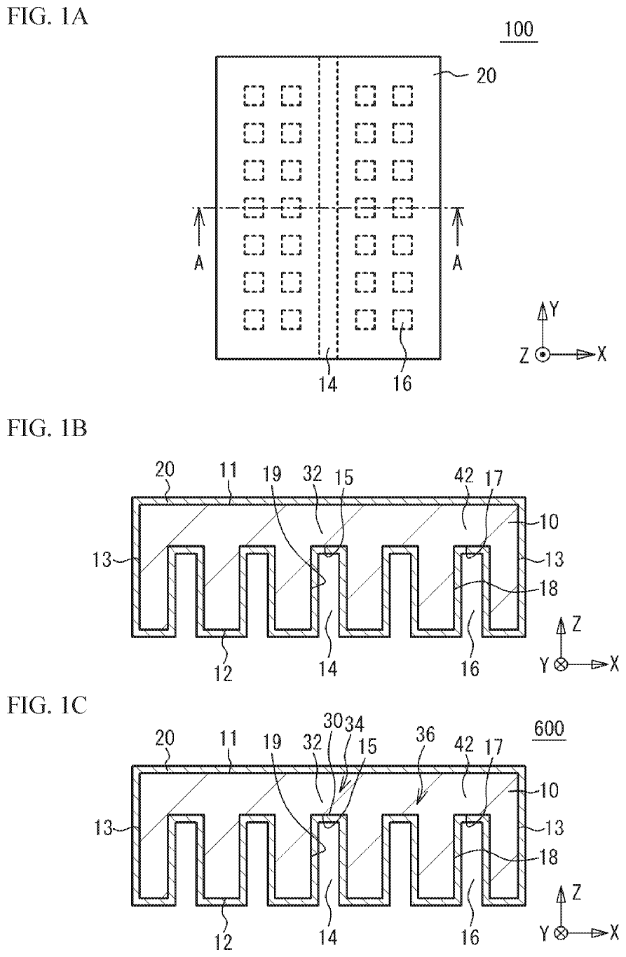

FIG. 1A is a plan view of a waveguide member 100 according to a first embodiment, and FIG. 1B is a cross-sectional view taken along a line A-A in FIG. 1A. FIG. 1C is a cross-sectional view of a waveguide device 600 using the waveguide member 100 of the first embodiment. The thickness direction of the member 10 made of a non-conductive material is defined as a Z-axis direction. The directions orthogonal to the Z-axis direction and orthogonal to each other are defined as an X-axis direction and a Y-axis direction. The expressions “upper” and “lower” used in the present specification and the claims are used for convenience in order to make the description of the relative position of an object easier to understand, and do not limit the scope of the claimed invention.

As illustrated in FIGS. 1A and 1B, the waveguide member 100 includes a member 10 and a conductive film 20. The member 10 has an upper surface 11, a lower surface 12, four side surfaces 13 connected to a peripheral edge of the upper surface 11 and a peripheral edge of the lower surface 12, a belt portion 14 recessed from the lower surface 12 toward the upper surface 11, and a plurality of hole portions 16 extending from the lower surface 12 toward the upper surface 11. The member 10 is formed of a resin material such as polyimide. In the present specification, the “upper surface” refers to an aggregate of surfaces that can be captured on the surface of the member 10 when the member 10 disposed along an XY plane is viewed from the +Z axis direction. The term “lower surface” is used in the same meaning.

The belt portion 14 has a first ceiling surface 15 extending in a belt shape and inner side surfaces 19 connected to the first ceiling surface 15. The belt portion 14 extends in the Y-axis direction. The first ceiling surface 15 and the upper surface 11 are surfaces facing each other, and the member 10 is present in a region 32 between the first ceiling surface 15 and the upper surface 11. In the present specification, the “facing surface” refers to a surface that is in the field of view when the other surface is viewed from an observation point on one surface in the Z-axis direction. At least a part of the inner side surfaces 19 of the belt portion 14 may be tapered so as to widen downward.

At least a part of the plurality of hole portions 16 is disposed adjacent to the belt portion 14. The hole portion 16 has a second ceiling surface 17 and side peripheral surfaces 18 connected to the second ceiling surface 17. The second ceiling surface 17 and the upper surface 11 are surfaces facing each other, and the member 10 is present in a region 42 between the second ceiling surface 17 and the upper surface 11. The hole portion 16 has, for example, a rectangular shape when viewed from the Z-axis direction, but is not limited to this case, and may have another shape such as a circular shape or an elliptical shape. At least a part of the side peripheral surfaces 18 of the hole portion 16 may be tapered so as to widen downward.

The conductive film 20 is provided to cover all the surfaces of the member 10. That is, the conductive film 20 covers the upper surface 11, the lower surface 12, and the four side surfaces 13 of the member 10, the first ceiling surface 15 and the inner side surfaces 19 of the belt portion 14, and the second ceiling surface 17 and the side peripheral surfaces 18 of the hole portion 16. The belt portion 14 and the hole portion 16 are hollow inside the conductive film 20. Note that the space may not be hollow, and at least a part of the space may be covered with or filled with a non-conductive material. The conductive film 20 is a conductive metal film containing, for example, copper, nickel, or the like. The conductive film 20 provided on the first ceiling surface 15 of the belt portion 14 and the conductive film 20 provided on the second ceiling surface 17 of the hole portion 16 face the conductive film 20 provided on the upper surface 11 of the member 10 with the member 10 interposed therebetween. The conductive film 20 provided on the inner side surfaces 19 of the belt portion 14 is in contact with the conductive film 20 provided on the first ceiling surface 15 and the conductive film 20 provided on the lower surface 12. The conductive film 20 provided on the side peripheral surfaces 18 of the hole portion 16 is in contact with the conductive film 20 provided on the second ceiling surface 17 and the conductive film 20 provided on the lower surface 12. The term “contact” means that the conductive film 20 provided on the inner side surfaces 19 or the side peripheral surfaces 18 is connected to the conductive film 20 provided on the first ceiling surface 15 or the second ceiling surface 17 and the conductive film 20 provided on the lower surface 12 while ensuring electrical conduction therebetween.

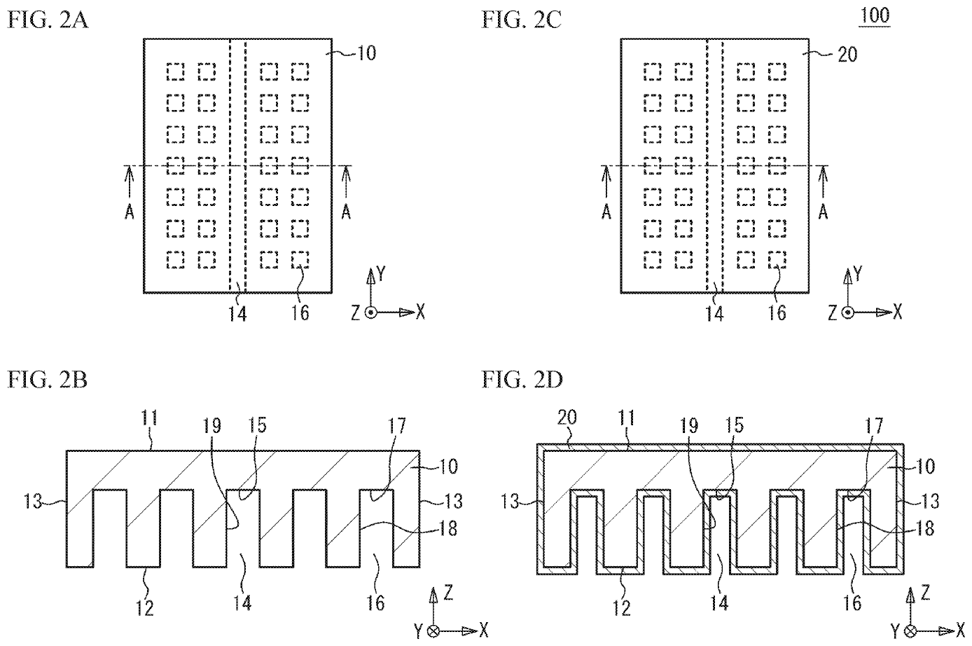

Thus, the waveguide member 100 has a structure in which the conductive film 20 is provided so as to cover the surface of the member 10 having the belt portion 14 recessed from the lower surface 12 toward the upper surface 11 and the plurality of hole portions 16 extending from the lower surface 12 toward the upper surface 11. Such a structure can be manufactured by a method illustrated in FIGS. 2A to 2D described later, and thus can be manufactured simply and inexpensively. In particular, the conductive film 20 covering all the surfaces of the member 10 makes the manufacture simpler and cheaper.

As illustrated in FIG. 1C, in the waveguide device 600 using the waveguide member 100 according to the first embodiment, the conductive film 20 on the first ceiling surface 15 forms a waveguide surface 30. The waveguide surface 30 faces the conductive film 20 on the upper surface 11 with the member 10 interposed therebetween, and extends in the Y-axis direction along the belt portion 14. A ridge waveguide 34 (WRG: Waffle-iron Ridge waveGuide) through which electromagnetic waves propagate is formed in the region 32 between the conductive film 20 of the first ceiling surface 15 and the conductive film 20 of the upper surface 11.

The conductive film 20 is provided on the second ceiling surfaces 17 and the side peripheral surfaces 18 of the plurality of hole portions 16 disposed adjacent to the belt portion 14, and thus the hole portions 16 function as magnetic walls that suppress the leakage of an electromagnetic wave propagating through the ridge waveguide 34 to the sides. That is, the conductive film 20 in the hole portion 16 forms an electromagnetic wave propagation barrier 36 that suppresses the leakage of the electromagnetic wave propagating through the ridge waveguide 34. Here, “adjacent” means a state where the hole portion 16 is disposed in proximity to the belt portion 14 without interposing a conductive object other than the conductive film 20 at a position where a required function, that is, a function of realizing an electromagnetic wave shielding function in a case of being used as a magnetic wall, is realized. In this case, a distance between the adjacent conductive films 20 is, for example, about λ₀/4. Note that, in a case where a required function can be realized even at a distance equal to or longer than this, the distance is included in “adjacent”. The λ₀ is a representative value of the wavelength in free space of the electromagnetic wave propagating through the ridge waveguide 34 (for example, a wavelength corresponding to the center frequency of the used band (operating frequency band)). The ridge waveguide 34 propagates electromagnetic waves in a microwave band or a millimeter-wave band with low loss.

Various dimensions of the belt portion 14 and the hole portion 16 are defined by the wavelength of the electromagnetic wave propagating through the ridge waveguide 34. For example, the various dimensions of a waveguide member and a conductive rod described in Patent Document 4 can be applied to the various dimensions of the belt portion 14 and the hole portion 16. The waveguide member of Patent Document 4 corresponds to the belt portion 14, and the conductive rod correspond to the hole portion 16.

Since the waveguide member 100 can be manufactured simply and inexpensively as illustrated in FIGS. 2A to 2D described later, the waveguide device 600 can also be manufactured simply and inexpensively. In addition, since the ridge waveguide 34 is filled with the member 10, the wavelength of the electromagnetic wave propagating through the ridge waveguide 34 is shorter than that in a case where the ridge waveguide 34 is a void. Since the various dimensions of the belt portion 14 and the hole portion 16 are defined by the wavelength of the electromagnetic wave propagating through the ridge waveguide 34, the various dimensions of the belt portion 14 and the hole portion 16 are reduced. This enables the waveguide member 100 and the waveguide device 600 to be made smaller. In particular, the present disclosure may be useful in the case where electromagnetic waves in the terahertz band propagate.

### [Manufacturing Method]

FIG. 2A and FIG. 2C are plan views illustrating a method of manufacturing the waveguide member 100 according to the first embodiment, and FIGS. 2B and 2D are cross-sectional views taken along a line A-A in FIGS. 2A and 2C. As illustrated in FIGS. 2A and 2B, the member 10 is formed, which has the belt portion 14 recessed from the lower surface 12 toward the upper surface 11, and the plurality of hole portions 16 extending from the lower surface 12 toward the upper surface 11 and arranged adjacent to at least a part of the belt portion 14. The member 10 is formed by, for example, molding using a mold. The member 10 may be formed by cutting a member having a rectangular parallelepiped shape with a drill or the like to form the belt portion 14 and the hole portions 16.

As illustrated in FIGS. 2C and 2D, the conductive film 20 covering all the surfaces of the member 10 is formed. The conductive film 20 is formed by, for example, an electroplating method or an electroless plating method. The conductive film 20 is a conductive metal film containing, for example, copper, nickel, or the like. This forms the waveguide member 100 according to the first embodiment.

### [Modifications]

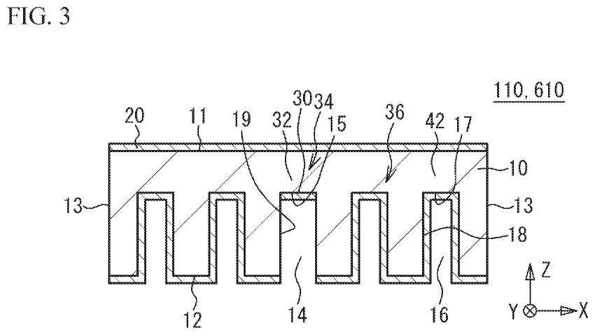

FIG. 3 is a cross-sectional view of a waveguide member 110 and a waveguide device 610 using the waveguide member 110 according to a modification of the first embodiment. As illustrated in FIG. 3, in the modification of the first embodiment, the conductive film 20 covers only the upper surface 11, the lower surface 12, the first ceiling surface 15 of the belt portion 14, and the second ceiling surfaces 17 and the side peripheral surfaces 18 of the hole portions 16, among the surfaces of the member 10. Note that the conductive film 20 may not be provided on a part of the side peripheral surfaces 18 of the hole portion 16, and at least the conductive film 20 on the second ceiling surface 17 and the conductive film 20 on the lower surface 12 are in contact with each other at any part. The other configurations of the modification are the same as those of the first embodiment, and the description thereof will be omitted.

The waveguide member 110 according to the modification of the first embodiment is manufactured by the same method as the waveguide member 100 according to the first embodiment, except that a mask layer is formed on the side surfaces 13 of the member 10 and the inner side surfaces 19 of the belt portion 14 on which the conductive film 20 is not formed, then the conductive film 20 is formed by electroplating or electroless plating, and then the mask layer is removed. Thus, the waveguide member 110 according to the modification of the first embodiment can also be manufactured simply and inexpensively.

In the waveguide device 610 using the waveguide member 110 according to the modification of the first embodiment, as in the waveguide device 600 of the first embodiment, the conductive film 20 on the first ceiling surface 15 forms the waveguide surface 30, and the ridge waveguide 34 is formed in the region 32 between the conductive film 20 on the first ceiling surface 15 and the conductive film 20 on the upper surface 11. The conductive film 20 in the plurality of hole portions 16 forms the electromagnetic wave propagation barrier 36 that suppresses the leakage of the electromagnetic wave propagating through the ridge waveguide 34. Since the waveguide member 110 according to the modification of the first embodiment can be manufactured simply and inexpensively, the waveguide device 610 can also be manufactured simply and inexpensively. Further, since the ridge waveguide 34 is filled with the member 10, the waveguide device 610 can be downsized as in the first embodiment.

### Second Embodiment

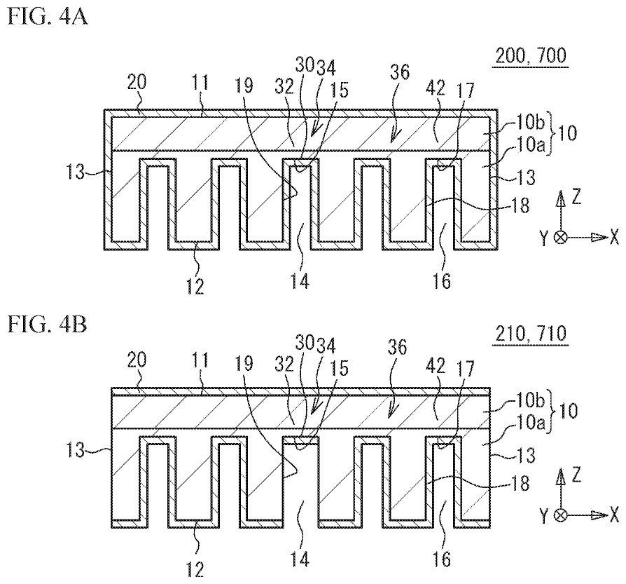

FIG. 4A is a cross-sectional view of a waveguide member 200 and a waveguide device 700 using the waveguide member 200 according to a second embodiment. As illustrated in FIG. 4A, in the second embodiment, the member 10 includes a first portion 10a that forms the lower surface 12, and a second portion 10b that has a dielectric constant different from that of the first portion 10a and forms the upper surface 11. The second portion 10b is located in at least a part of the region 32 between the first ceiling surface 15 of the belt portion 14 and the upper surface 11 of the member 10 and in at least a part of the region 42 between the second ceiling surfaces 17 of the hole portions 16 and the upper surface 11 of the member 10. For example, the first portion 10a is formed of polyimide, and the second portion 10b is formed of benzocyclobutene (BCB) or syndiotactic polystyrene (SPS). In the region 32, the thickness of the second portion 10b may be, for example, thicker than the first portion 10a, and may be 1.2 times or more, 1.5 times or more, or 2.0 times or more. The other configurations of the second embodiment are the same as those of the first embodiment, and the description thereof will be omitted.

The waveguide member 200 according to the second embodiment is manufactured by the same method as the waveguide member 100 according to the first embodiment illustrated in FIGS. 2A to 2D, except that the member 10 having the first portion 10a that forms the lower surface 12 and the second portion 10b that has a dielectric constant different from that of the first portion 10a and forms the upper surface 11 is formed by, for example, molding. Accordingly, the waveguide member 200 according to the second embodiment can also be manufactured simply and inexpensively. Also, the waveguide device 700 using the waveguide member 200 can be manufactured simply and inexpensively.

FIG. 4B is a cross-sectional view of a waveguide member 210 according to a modification of the second embodiment and a waveguide device 710 using the waveguide member 210. As illustrated in FIG. 4B, in the modification of the second embodiment, the conductive film 20 covers only the upper surface 11, the lower surface 12, the first ceiling surface 15 of the belt portion 14, and the second ceiling surfaces 17 and the side peripheral surfaces 18 of the hole portions 16, among the surfaces of the member 10. The other configurations of the modification are the same as those of the second embodiment, and the description thereof is omitted.

The waveguide member 210 according to the modification of the second embodiment is manufactured by the same method as that for the waveguide member 200 according to the second embodiment, except that a mask layer is formed on the side surfaces 13 of the member 10 and the inner side surfaces 19 of the belt portion 14 on which the conductive film 20 is not formed, then the conductive film 20 is formed by the electroplating method or the electroless plating method, and then the mask layer is removed. Accordingly, the waveguide member 210 according to the modification of the second embodiment can also be manufactured simply and inexpensively. Also, the waveguide device 710 using the waveguide member 210 can be manufactured simply and inexpensively.

As illustrated in FIGS. 4A and 4B, in the waveguide devices 700 and 710 using the waveguide members according to the second embodiment and the modification thereof, the conductive film 20 on the first ceiling surface 15 forms the waveguide surface 30, and the ridge waveguide 34 is formed in the region 32 between the conductive film 20 on the first ceiling surface 15 and the conductive film 20 on the upper surface 11. The conductive film 20 in the plurality of hole portions 16 forms the electromagnetic wave propagation barrier 36 that suppresses the leakage of the electromagnetic wave propagating through the ridge waveguide 34.

For example, at the center frequency of the operating frequency band, a dielectric loss tangent tan δ of the second portion 10b is less than the dielectric loss tangent tan δ of the first portion 10a. Since the second portion 10b having such a small dielectric loss tangent tan δ is located in at least a part between the first ceiling surface 15 of the belt portion 14 and the upper surface 11 of the member 10, the loss of electromagnetic waves propagating through the ridge waveguide 34 can be reduced as compared with the case where the member 10 is entirely formed of the first portion 10a.

For example, at the center frequency of the operating frequency band, the relative dielectric constant of the first portion 10a is greater than the relative dielectric constant of the second portion 10b. Since the first portion 10a having a large relative dielectric constant is provided around the belt portion 14, the various dimensions of the belt portion 14 and the hole portions 16 are reduced as compared with a case where the member 10 is entirely formed of the second portion 10b. Therefore, the waveguide member and the waveguide device can be downsized.

From the viewpoint of reducing the loss of electromagnetic waves, the dielectric loss tangent tan δ of the second portion 10b is preferably 0.9 times or less, more preferably 0.8 times or less, and still more preferably 0.7 times or less the dielectric loss tangent tan δ of the first portion 10a at the center frequency of the operating frequency band. From the viewpoint of downsizing, the relative dielectric constant of the first portion 10a is preferably 1.1 times or more, more preferably 1.2 times or more, and still more preferably 1.3 times or more the relative dielectric constant of the second portion 10b at the center frequency of the operating frequency band. A material having a large dielectric loss tangent tan δ tends to have a large relative dielectric constant.

### Third Embodiment

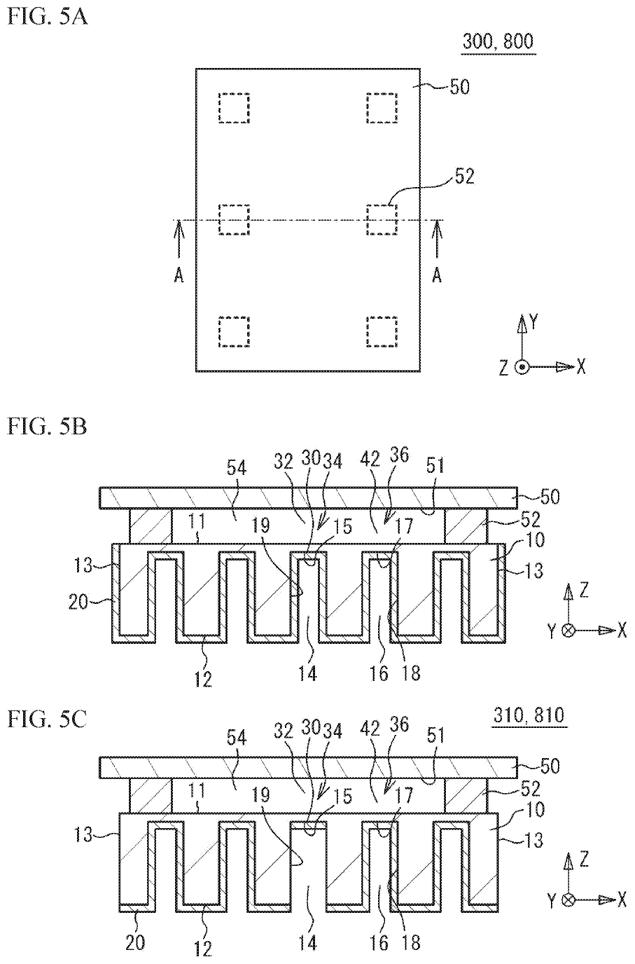

FIG. 5A is a plan view of a waveguide member 300 and a waveguide device 800 using the waveguide member 300 according to the third embodiment, and FIG. 5B is a cross-sectional view taken along a line A-A in FIG. 5A. FIG. 5C is a cross-sectional view of a waveguide member 310 according to a modification of the third embodiment and a waveguide device 810 using the waveguide member 310. In FIG. 5A, only a member 50 and spacers 52 are illustrated for the sake of clarity of the drawing. As illustrated in FIGS. 5A and 5B, in the third embodiment, the conductive film 20 is not provided on the upper surface 11 of the member 10 (first member). The member 50 (second member) is provided on the upper surface 11 side via the plurality of spacers 52. In the present specification, the term “upper surface side” is used to mean “above including the upper surface”. The spacers 52 are provided on the peripheral edge portions of the upper surface 11 of the member 10, and are disposed at positions not overlapping the belt portion 14 when viewed from the +Z axis direction. The spacers 52 are formed of metal, resin, ceramic, or the like. The spacers 52 may be formed of the same material as the member 10. At least a lower surface 51 of the member 50 has conductivity. The member 50 may be a member formed by processing such as molding or cutting a conductive metal, or may have a structure in which a conductive film such as a metal film formed by plating, coating, surface treatment, or the like is provided on a surface of an insulating member such as a resin. The member 10 and an air gap 54 are present in the region 32 between the first ceiling surface 15 of the belt portion 14 and the conductive lower surface 51 of the member 50.

The member 10 and the air gap 54 are also present in the region 42 between the second ceiling surfaces 17 of the plurality of hole portions 16 and the conductive lower surface 51 of the member 50. The other configurations of the third embodiment are the same as those of the first embodiment, and the description thereof will be omitted.

As illustrated in FIG. 5C, in the modification of the third embodiment, the conductive film 20 covers only the lower surface 12, the first ceiling surface 15 of the belt portion 14, and the second ceiling surfaces 17 and the side peripheral surfaces 18 of the hole portions 16, among the surfaces of the member 10. The other configurations of the modification are the same as those of the third embodiment, and the description thereof is omitted.

As illustrated in FIGS. 5B and 5C, in the waveguide devices 800 and 810 using the waveguide members according to the third embodiment and the modification of the third embodiment, the conductive film 20 on the first ceiling surface 15 forms the waveguide surface 30, and the ridge waveguide 34 composed of the member 10 and the air gap 54 is formed in the region 32 between the conductive film 20 on the first ceiling surface 15 and the conductive film 20 on the upper surface 11. The conductive film 20 in the plurality of hole portions 16 forms the electromagnetic wave propagation barrier 36 that suppresses the leakage of the electromagnetic wave propagating through the ridge waveguide 34.

### [Manufacturing Method]

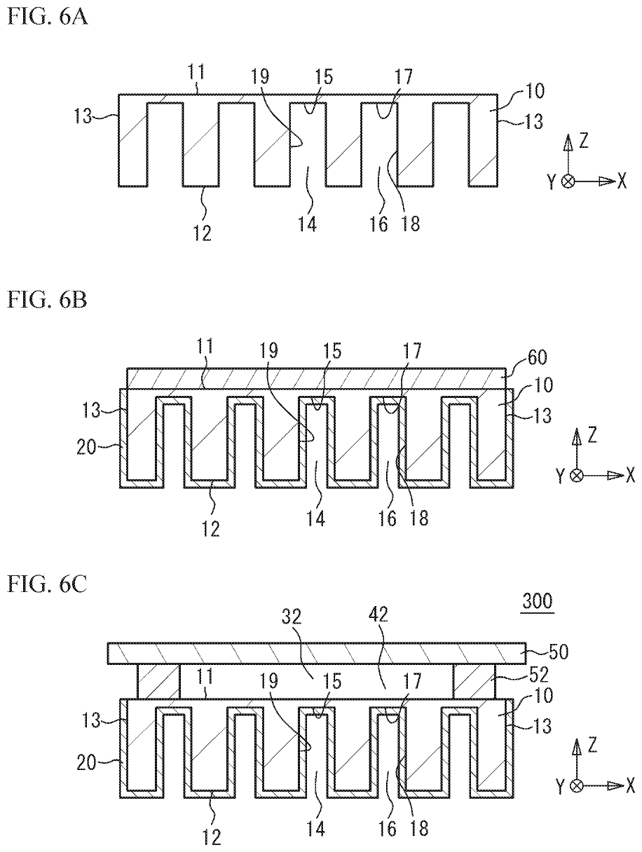

FIGS. 6A to 6C are cross-sectional views illustrating a method of manufacturing the waveguide member 300 according to the third embodiment. As illustrated in FIG. 6A, the member 10 is formed, which has the belt portion 14 recessed from the lower surface 12 toward the upper surface 11 and the plurality of hole portions 16 extending from the lower surface 12 toward the upper surface 11. The member 10 may be formed by molding using a mold, or may be formed by cutting a member having a rectangular parallelepiped shape with a drill or the like, as in the first embodiment.

As illustrated in FIG. 6B, after a mask layer 60 is formed on the upper surface 11, the conductive film 20 is formed by the electroplating method or the electroless plating method using the mask layer 60 as a mask. Thus, the conductive film 20 covering all the surfaces of the member 10 other than the upper surface 11 is formed. The mask layer 60 is formed of, for example, a resist.

As illustrated in FIG. 6C, after the mask layer 60 is removed, the member 50 is disposed on the upper surface 11 side of the member 10 via the plurality of spacers 52. This forms the waveguide member 300 according to the third embodiment. The spacers 52 may be formed by disposing a member made of a material different from that of the member 10 on the upper surface 11 side, or may be formed by integral molding that realizes a structure made of the same material as that of the member 10 and continuous with the member 10.

The waveguide member 310 according to the modification of the third embodiment is manufactured by the same method as that for the waveguide member 300 according to the third embodiment, except that a mask layer is formed on the upper surface 11 and the side surfaces 13 of the member 10 and the inner side surfaces 19 of the belt portion 14 on which the conductive film 20 is not formed, then the conductive film 20 is formed by the electroplating method or the electroless plating method, and then the mask layer is removed.

As described above, the waveguide members 300 and 310 according to the third embodiment and the modification thereof can be manufactured simply and inexpensively. Accordingly, the waveguide devices 800 and 810 using the waveguide members according to the third embodiment and the modification thereof can also be manufactured simply and inexpensively. In particular, when the conductive film 20 covers all the surfaces other than the upper surface 11 of the member 10, the waveguide members and the waveguide devices can be manufactured more simply and inexpensively.

The conductive film 20 is not provided on the upper surface 11 of the member 10, and the member 50 is provided on the upper surface 11 side via the plurality of spacers 52. Therefore, the air gap 54 made of, for example, air is formed in the region 32 between the first ceiling surface 15 of the member 10 and the lower surface 51 of the member 50, in which the ridge waveguide 34 is formed. Since the dielectric loss of air is smaller than the dielectric loss of resin or the like, the loss of electromagnetic waves propagating through the ridge waveguide 34 can be reduced. Also, since the member 10 is provided around the belt portion 14, the various dimensions of the belt portion 14 and the hole portion 16 are reduced, and the waveguide member and the waveguide device can be downsized.

### Fourth Embodiment

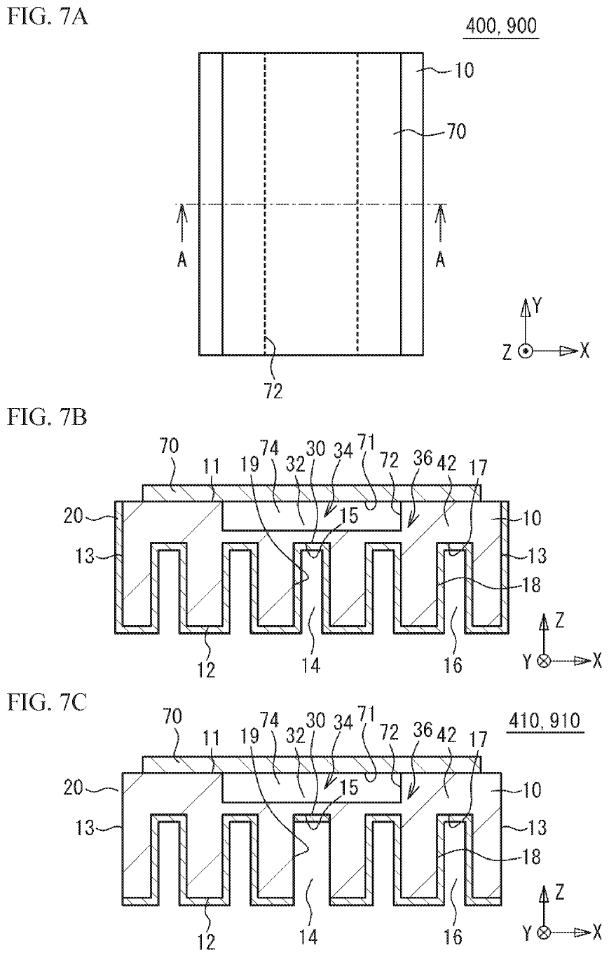

FIG. 7A is a plan view of a waveguide member 400 and a waveguide device 900 using the waveguide member 400 according to a fourth embodiment, and FIG. 7B is a cross-sectional view taken along a line A-A in FIG. 7A. FIG. 7C is a cross-sectional view of a waveguide member 410 and a waveguide device 910 using the waveguide member 410 according to a modification of the fourth embodiment. In FIG. 7A, only the member 10, a recess 72, and a member 70 are illustrated for the sake of clarity of the drawing. As illustrated in FIGS. 7A and 7B, in the fourth embodiment, the recess 72 is provided in the upper surface 11 of the member 10 (first member). The recess 72 is disposed at a position facing at least the first ceiling surface 15 of the belt portion 14, and extends in the Y-axis direction. The conductive film 20 is not provided on the upper surface 11. The member 70 (second member) covering the recess 72 is provided on the upper surface 11. The member 70 extends in the Y-axis direction and completely covers the recess 72. At least a lower surface 71 of the member 70 has conductivity. The member 70 may be a member formed by processing such as molding or cutting a conductive metal, or may have a structure in which a conductive film such as a metal film formed by plating, coating, surface treatment, or the like is provided on the surface of an insulating member such as a resin. The member 10 and an air gap 74 are present in the region 32 between the first ceiling surface 15 of the belt portion 14 and the conductive lower surface 71 of the member 70. In the region 42 between the second ceiling surface 17 and the conductive lower surface 71 of the member 70, there is a mixture of a case where the member 10 and the air gap 74 are present, and a case where only the member 10 is present. The other configurations of the fourth embodiment are the same as those of the first embodiment, and the description thereof will be omitted.

As illustrated in FIG. 7C, in the modification of the fourth embodiment, the conductive film 20 covers only the lower surface 12, the first ceiling surface 15 of the belt portion 14, and the second ceiling surface 17 and the side peripheral surfaces 18 of the hole portions 16, among the surfaces of the member 10. The other configurations of the modification are the same as those of the fourth embodiment, and the description thereof is omitted.

As illustrated in FIGS. 7B and 7C, in the waveguide devices 900 and 910 using the waveguide members according to the fourth embodiment and the modification of the fourth embodiment, the conductive film 20 on the first ceiling surface 15 forms the waveguide surface 30, and the ridge waveguide 34 composed of the member 10 and the air gap 74 is formed in the region 32 between the conductive film 20 on the first ceiling surface 15 and the member 70. The conductive film 20 in the plurality of hole portions 16 forms the electromagnetic wave propagation barrier 36 that suppresses the leakage of the electromagnetic wave propagating through the ridge waveguide 34.

### [Manufacturing Method]

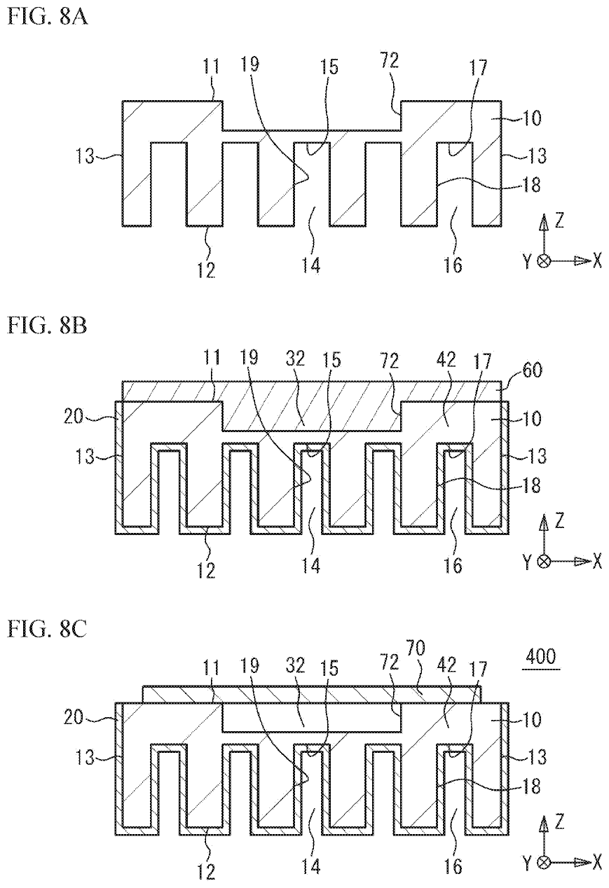

FIGS. 8A to 8C are cross-sectional views illustrating a method of manufacturing the waveguide member 400 according to the fourth embodiment. As illustrated in FIG. 8A, the member 10 is formed, which includes the belt portion 14 recessed from the lower surface 12 toward the upper surface 11, the plurality of hole portions 16 extending from the lower surface 12 toward the upper surface 11, and the recess 72 provided on the upper surface 11 so as to face the belt portion 14. The member 10 may be formed by molding using a mold, or may be formed by cutting a member having a rectangular parallelepiped shape with a drill or the like, as in the first embodiment.

As illustrated in FIG. 8B, after the mask layer 60 is formed on the upper surface 11 and the recess 72, the conductive film 20 is formed by the electroplating method or the electroless plating method using the mask layer 60 as a mask. As a result, the conductive film 20 covering all the surfaces of the member 10 other than the upper surface 11 and the recess 72 is formed. The mask layer 60 is formed of, for example, a resist.

As illustrated in FIG. 8C, after the mask layer 60 is removed, the member 70 covering the recess 72 is disposed on the upper surface 11 of the member 10. This forms the waveguide member 400 according to the fourth embodiment.

The waveguide member 410 according to the modification of the fourth embodiment is manufactured by the same method as the waveguide member 400 according to the fourth embodiment, except that a mask layer is formed on the upper surface 11, the recess 72 and the side surfaces 13 of the member 10 and the inner side surfaces 19 of the belt portion 14 on which the conductive film 20 is not formed, and then the conductive film 20 is formed by the electroplating method or the electroless plating method, and then the mask layer is removed.

As described above, the waveguide members 400 and 410 according to the fourth embodiment and the modification thereof can be manufactured simply and inexpensively. Accordingly, the waveguide devices 900 and 910 using the waveguide members according to the fourth embodiment and the modification thereof can also be manufactured simply and inexpensively. In particular, when the conductive film 20 covers all the surfaces of the member 10 other than the upper surface 11 and the recess 72, the waveguide members and the waveguide devices can be manufactured more simply and inexpensively.

In addition, the recess 72 is formed in the upper surface 11 of the member 10 at a position corresponding to at least the first ceiling surface 15 of the belt portion 14, and the member 70 is provided to cover the recess 72. Therefore, the air gap 74 is formed in the region 32 between the first ceiling surface 15 of the member 10 and the lower surface 71 of the member 70, in which the ridge waveguide 34 is formed. Therefore, the loss of the electromagnetic wave propagating through the ridge waveguide 34 can be reduced. Also, since the member 10 is provided around the belt portion 14, the various dimensions of the belt portion 14 and the hole portion 16 are reduced, and the waveguide member and the waveguide device can be downsized.

### Fifth Embodiment

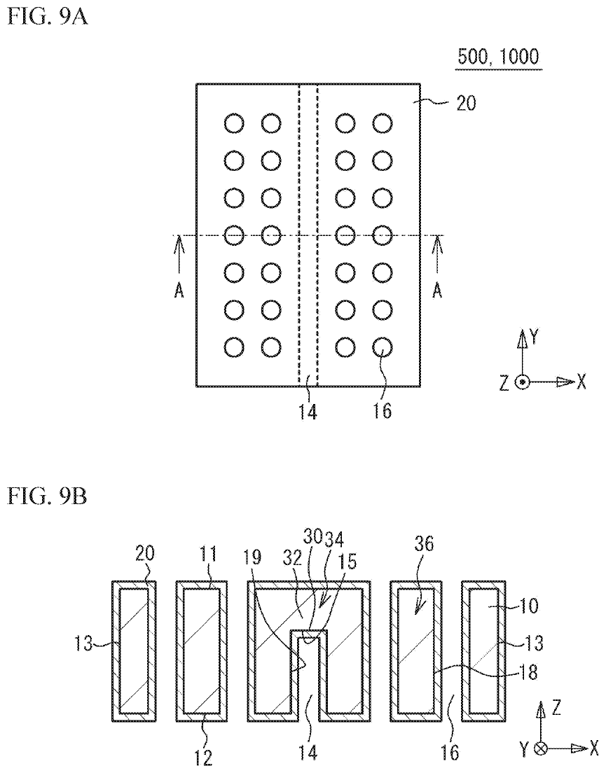

FIG. 9A is a plan view of a waveguide member 500 and a waveguide device 1000 using the waveguide member 500 according to a fifth embodiment, and FIG. 9B is a cross-sectional view taken along a line A-A in FIG. 9A. As illustrated in FIGS. 9A and 9B, in the fifth embodiment, the hole portion 16 provided in the member 10 penetrates from the lower surface 12 to the upper surface 11, and has a circular shape when viewed from the Z-axis direction. The other configurations of the fifth embodiment are the same as those of the first embodiment, and thus the description thereof will be omitted.

In the waveguide device 1000 using the waveguide member according to the fifth embodiment, the conductive film 20 on the first ceiling surface 15 forms the waveguide surface 30, and the ridge waveguide 34 is formed in the region 32 between the conductive film 20 on the first ceiling surface 15 and the conductive film 20 on the upper surface 11. The conductive film 20 of the plurality of hole portions 16 functions as an electric wall, and the electromagnetic wave propagation barrier 36 that suppresses the leakage of the electromagnetic wave propagating through the ridge waveguide 34 is formed.

### [Manufacturing Method]

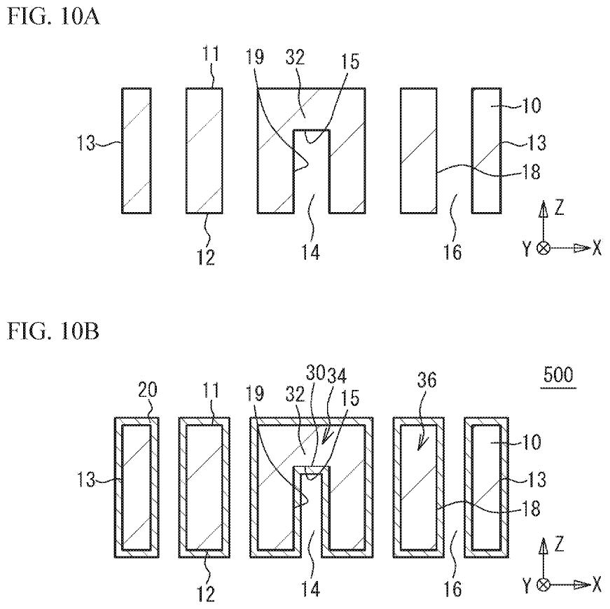

FIGS. 10A and 10B are cross-sectional views illustrating a method of manufacturing the waveguide member 500 according to the fifth embodiment. As illustrated in FIG. 10A, the member 10 is formed which has the belt portion 14 recessed from the lower surface 12 toward the upper surface 11 and the plurality of hole portions 16 penetrating from the lower surface 12 to the upper surface 11. The member 10 may be formed by molding using a mold, or may be formed by cutting a member having a rectangular parallelepiped shape with a drill or the like, as in the first embodiment.

As illustrated in FIG. 10B, the conductive film 20 is formed to cover all the surfaces of the member 10. The conductive film 20 is formed by, for example, the electrolytic plating method or the electroless plating method. Thus, the waveguide member 500 according to the fifth embodiment is formed.

Thus, the waveguide member 500 according to the fifth embodiment can be manufactured simply and inexpensively. Accordingly, the waveguide device 1000 using the waveguide member according to the fifth embodiment can also be manufactured simply and inexpensively. Also, since the member 10 is provided around the belt portion 14, the various dimensions of the belt portion 14 and the hole portion 16 are reduced, and the waveguide member and the waveguide device can be downsized.

### Sixth Embodiment

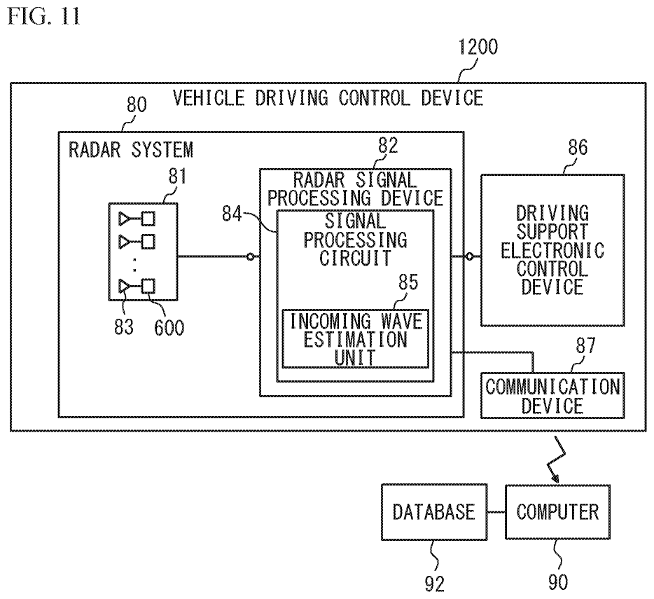

FIG. 11 is a block diagram illustrating a vehicle driving control device 1200 according to a sixth embodiment. As illustrated in FIG. 11, the vehicle driving control device 1200 includes a radar system 80 and a driving support electronic control device 86 connected to the radar system 80. The radar system 80 includes an array antenna 81 and a radar signal processing device 82. The array antenna 81 is capable of emitting a high frequency millimeter wave. The array antenna 81 includes a plurality of antenna elements 83 and the waveguide device 600 connected to the antenna elements 83. The antenna element 83 outputs a reception signal to the waveguide device 600 in response to one or more incoming waves. The array antenna 81 is attached to a vehicle. At least a part of the functions of the radar signal processing device 82 may be realized by a computer 90 and a database 92 provided outside the vehicle driving control device 1200. The database 92 stores programs that define various signal processing algorithms. The contents of the data and programs necessary for the operation of the radar system 80 are updated from the outside via a communication device 87.

The radar signal processing device 82 includes a signal processing circuit 84. The signal processing circuit 84 receives the reception signal from the array antenna 81, and inputs the reception signal or a secondary signal generated from the reception signal to an incoming wave estimation unit 85. The signal processing circuit 84 is configured to perform an arithmetic operation using the reception signal or the secondary signal and output a signal indicating the number of incoming waves. The signal indicating the number of incoming waves is a signal indicating the number of one or more preceding vehicles driving in front of a self vehicle.

The incoming wave estimation unit 85 estimates an angle indicating the direction of the incoming wave, and outputs a signal indicating an estimation result. The signal processing circuit 84 estimates a distance to a target which is a wave source of the incoming wave, a relative speed of the target, and the direction of the target by known algorithms executed by the incoming wave estimation unit 85, and outputs a signal indicating the estimation result.

The driving support electronic control device 86 is configured to perform driving support for the vehicle based on various signals output from the radar signal processing device 82. The driving support electronic control device 86 instructs various electronic control units to perform a function of issuing an alarm to prompt a driver to perform a brake operation when the inter-vehicle distance becomes shorter than a set value, a function of controlling the brake, a function of controlling the accelerator, and the like.

Although FIG. 11 illustrates a case where the waveguide device 600 in the first embodiment is included, the waveguide device described in any of the modifications of the first embodiment to the fifth embodiment may be included. Furthermore, the waveguide device is not limited to being used in a radar system such as a millimeter wave radar, and may be used in other devices.

Although the embodiments of the present disclosure have been described in detail above, the present disclosure is not limited to the specific embodiments, and various change, substitutions, and alterations could be made hereto without departing from the spirit and scope of the claimed invention.

What is claimed is:

1. A waveguide member comprising:
a member made of a non-conductive material, the member including an upper surface, a lower surface, a belt portion having a first ceiling surface recessed from the lower surface toward the upper surface and extending in a belt shape, and a plurality of hole portions extending from the lower surface toward the upper surface and disposed adjacent to at least a part of the belt portion, the plurality of hole portions each having a second ceiling surface and a side peripheral surface; and
a conductive film that covers at least the upper surface and the lower surface of the member, and the first ceiling surface of the belt portion, and the second ceiling surface and the side peripheral surface of each of the plurality of hole portions.

2. The waveguide member according to claim 1, wherein
the member includes a first portion that forms the lower surface, and a second portion that has a dielectric constant different from that of the first portion, forms the upper surface, and is located in at least a part between the first ceiling surface of the belt portion and the upper surface.

3. The waveguide member according to claim 1, wherein
the conductive film covers all surfaces of the member.

4. A waveguide member comprising:
a first member made of a non-conductive material, the first member including an upper surface, a lower surface, a belt portion having a first ceiling surface recessed from the lower surface toward the upper surface and extending in a belt shape, and a plurality of hole portions extending from the lower surface toward the upper surface and disposed adjacent to at least a part of the belt portion, the plurality of hole portions each having a second ceiling surface and a side peripheral surface;
a conductive film that covers at least the lower surface of the first member, the first ceiling surface of the belt portion, and the second ceiling surface and the side peripheral surface of each of the plurality of hole portions; and
a second member provided on an upper surface side of the first member, the second member having a lower surface having conductivity.

5. The waveguide member according to claim 4, wherein
the second member is provided on the upper surface side of the first member via a plurality of spacers.

6. The waveguide member according to claim 5, wherein
the conductive film covers all surfaces of the first member other than the upper surface of the first member.

7. The waveguide member according to claim 4, wherein
the first member includes a recess provided on the upper surface, the recess being disposed at a position at least facing the first ceiling surface of the belt portion, and
the second member is provided on the upper surface of the first member so as to cover the recess.

8. The waveguide member according to claim 7, wherein
the conductive film covers all surfaces of the first member other than the upper surface of the first member and the recess.

9. A waveguide member comprising:
a member made of a non-conductive material, the member including an upper surface, a lower surface, a belt portion having a first ceiling surface recessed from the lower surface toward the upper surface and extending in a belt shape, and a plurality of hole portions penetrating from the lower surface to the upper surface and disposed adjacent to at least a part of the belt portion; and
a conductive film covering all surfaces of the member.

10. A waveguide device comprising:
a waveguide member according to claim 1,
wherein a waveguide is formed between the conductive film provided on the first ceiling surface and the conductive film provided on the upper surface, and an electromagnetic wave propagation barrier is formed by the conductive film provided in the plurality of hole portions.

11. A waveguide device comprising:
a waveguide member according to claim 4,
wherein a waveguide is formed between the conductive film provided on the first ceiling surface and the second member, and an electromagnetic wave propagation barrier is formed by the conductive film provided in the plurality of hole portions.

12. A method of manufacturing a waveguide member comprising:
forming a member made of a non-conductive material, the member including an upper surface, a lower surface, a belt portion having a first ceiling surface recessed from the lower surface toward the upper surface and extending in a belt shape, and a plurality of hole portions extending from the lower surface toward the upper surface and disposed adjacent to at least a part of the belt portion, the plurality of hole portions each having a second ceiling surface and a side peripheral surface; and
forming a conductive film that covers at least the upper surface, the lower surface, the first ceiling surface of the belt portion, and the second ceiling surface and the side peripheral surface of each of the plurality of hole portions of the member.

13. The method of manufacturing the waveguide member according to claim 12, wherein
the forming the member includes forming the member having a first portion that forms the lower surface, and a second portion that has a dielectric constant different from that of the first portion, forms the upper surface, and is located in at least a part between the first ceiling surface and the upper surface.

14. The method of manufacturing the waveguide member according to claim 12, wherein
the forming the conductive film includes forming the conductive film covering all surfaces of the member.

15. A method of manufacturing a waveguide member comprising:
forming a first member made of a non-conductive material, the first member including an upper surface, a lower surface, a belt portion having a first ceiling surface recessed from the lower surface toward the upper surface and extending in a belt shape, and a plurality of hole portions extending from the lower surface toward the upper surface and disposed adjacent to at least a part of the belt portion, the plurality of hole portions each having a second ceiling surface and a side peripheral surface;
forming a conductive film that covers at least the lower surface of the first member, the first ceiling surface of the belt portion, and the second ceiling surface and the side peripheral surfaces of each of the plurality of hole portions; and
forming a second member on an upper surface side of the first member, the second member having a lower surface having conductivity.

16. The method of manufacturing the waveguide member according to claim 15, wherein
the forming the second member includes forming the second member on the upper surface side of the first member via a plurality of spacers.

17. The method of manufacturing the waveguide member according to claim 16, wherein
the forming the conductive film includes forming the conductive film that covers all surfaces of the first member other than the upper surface of the first member.

18. The method of manufacturing the waveguide member according to claim 15, wherein
the forming the first member includes forming the first member that includes a recess provided on the upper surface, the recess being disposed at a position at least facing the first ceiling surface of the belt portion, and
the forming the second member includes forming the second member on the upper surface of the first member so as to cover the recess.

19. The method of manufacturing the waveguide member according to claim 18, wherein
the forming the conductive film includes forming the conductive film that covers all surfaces of the first member other than the upper surface of the first member and the recess.

20. A method of manufacturing a waveguide member comprising:
forming a member made of a non-conductive material, the member including an upper surface, a lower surface, a belt portion having a first ceiling surface recessed from the lower surface toward the upper surface and extending in a belt shape, and a plurality of hole portions penetrating from the lower surface to the upper surface and disposed adjacent to at least a part of the belt portion; and
forming a conductive film covering all surfaces of the member.
